(19) United States
(12) Patent Application Publication
(10) Pub. No.: US 2024/0364070 A1
(43) Pub. Date: Oct. 31, 2024

(54) LASER APPARATUS, OPTICAL PATH ADJUSTING METHOD, AND ELECTRONIC DEVICE MANUFACTURING METHOD

(71) Applicant: Gigaphoton Inc., Tochigi (JP)

(72) Inventors: Atsushi FUCHIMUKAI, Oyama-shi (JP); Toru SUZUKI, Oyama-shi (JP)

(73) Assignee: Gigaphoton Inc., Tochigi (JP)

(21) Appl. No.: 18/766,700

(22) Filed: Jul. 9, 2024

Related U.S. Application Data
(63) Continuation of application No. PCT/JP2022/004940, filed on Feb. 8, 2022.

(51) Int. Cl. H01S 3/083; H01S 3/00; H01S 3/105

(52) U.S. Cl. CPC H01S 3/0835; H01S 3/0071; H01S 3/105

(57) ABSTRACT

A laser apparatus includes an oscillator that outputs a laser beam, an amplifier that amplifies the laser beam in a chamber including discharge electrodes, front-side and rear-side optical systems disposed at positions facing each other across the chamber and constituting a ring resonator including a first optical path and a second optical path intersecting between the pair of discharge electrodes, a front-side observation device for observation of the first and second optical paths between the front-side optical system and the chamber, and a rear-side observation device for observation of the first and second optical paths between the rear-side optical system and the chamber. Through the first optical path, the front-side optical system outputs, toward the rear-side optical system, the laser beam from the oscillator. Through the second optical path, the rear-side optical system outputs, toward the front-side optical system, the laser beam through the first optical path.

### CROSS-REFERENCE TO RELATED APPLICATIONS

The present application is a continuation application of International Application No. PCT/JP2022/004940, filed on Feb. 8, 2022, the entire contents of which are hereby incorporated by reference.

### BACKGROUND

### 1. Technical Field

The present disclosure relates to a laser apparatus, an optical path adjusting method, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

Spectral linewidths of spontaneous oscillation beams of the KrF excimer laser apparatus and the ArF excimer laser apparatus are as wide as from 350 pm to 400 pm. Therefore, when a projection lens is formed of a material that transmits ultraviolet light such as KrF and ArF laser beams, chromatic aberration may occur. As a result, the resolution may decrease. Thus, the spectral linewidth of the laser beam output from the gas laser apparatus needs to be narrowed to an extent that the chromatic aberration is ignorable. Therefore, in a laser resonator of the gas laser apparatus, a line narrowing module (LNM) including a line narrowing element (such as etalon or grating) may be provided in order to narrow the spectral linewidth. Hereinafter, a gas laser apparatus with a narrowed spectral linewidth is referred to as a line narrowing gas laser apparatus.

### LIST OF DOCUMENTS

### Patent Document

Patent Document 1: Japanese Unexamined Patent Application Publication No. 63-054791

### SUMMARY

A laser apparatus according to one aspect of the present disclosure includes an oscillator, an amplifier, a front-side optical system, a rear-side optical system, a front-side observation device, and a rear-side observation device. The oscillator is configured to output a laser beam. The amplifier is configured to amplify the laser beam in a chamber including a pair of discharge electrodes. The front-side optical system and the rear-side optical system are disposed at positions facing each other across the chamber and constitute a ring resonator including a first optical path and a second optical path intersecting between the pair of discharge electrodes. The front-side observation device allows for observation of the first optical path and the second optical path between the front-side optical system and the chamber. The rear-side observation device allows for observation of the first optical path and the second optical path between the rear-side optical system and the chamber. The first optical path is an optical path through which the front-side optical system outputs, toward the rear-side optical system, the laser beam incoming from the oscillator, and the second optical path is an optical path through which the rear-side optical system outputs, toward the front-side optical system, the laser beam incoming through the first optical path.

An optical path adjusting method according to one aspect of the present disclosure is an optical path adjusting method of a laser apparatus. The laser apparatus includes an oscillator configured to output a laser beam, an amplifier configured to amplify the laser beam in a chamber including a pair of discharge electrodes, a front-side optical system and a rear-side optical system disposed at positions facing each other across the chamber and constituting a ring resonator including a first optical path and a second optical path intersecting between the pair of discharge electrodes, a front-side observation device that allows for observation of the first optical path and the second optical path between the front-side optical system and the chamber, and a rear-side observation device that allows for observation of the first optical path and the second optical path between the rear-side optical system and the chamber, the first optical path is an optical path through which the front-side optical system outputs, toward the rear-side optical system, the laser beam incoming from the oscillator, and the second optical path is an optical path through which the rear-side optical system outputs, toward the front-side optical system, the laser beam incoming through the first optical path. The optical path adjusting method includes adjusting the rear-side optical system through observation of the first optical path and the second optical path using the rear-side observation device, adjusting the rear-side optical system through observation of the first optical path and the second optical path using the front-side observation device, and adjusting the front-side optical system through observation of an optical path of the laser beam output from the amplifier.

An electronic device manufacturing method according to one aspect of the present disclosure includes generating a laser beam with a laser apparatus, outputting the laser beam to an exposure apparatus, and exposing a photosensitive substrate to the laser beam within the exposure apparatus in order to manufacture an electronic device. The laser apparatus includes an oscillator configured to output a laser beam, an amplifier configured to amplify the laser beam in a chamber including a pair of discharge electrodes, a front-side optical system and a rear-side optical system disposed at positions facing each other across the chamber and constituting a ring resonator including a first optical path and a second optical path intersecting between the pair of discharge electrodes, a front-side observation device that allows for observation of the first optical path and the second optical path between the front-side optical system and the chamber, and a rear-side observation device that allows for observation of the first optical path and the second optical path between the rear-side optical system and the chamber, the first optical path is an optical path through which the front-side optical system outputs, toward the rear-side optical system, the laser beam incoming from the oscillator, and the second optical path is an optical path through which the rear-side optical system outputs, toward the front-side optical system, the laser beam incoming through the first optical path.

### BRIEF DESCRIPTION OF THE DRAWINGS

Some embodiments of the present disclosure will be described below, by way of example only, with reference to the accompanying drawings.

FIG. 1 is a top view schematically illustrating a configuration example of a laser apparatus according to a comparative example.

FIG. 2 is a side view schematically illustrating a configuration example of a master oscillator according to the comparative example.

FIG. 3 is a top view schematically illustrating an initial state of optical path adjustment according to the comparative example.

FIG. 4 is a diagram schematically illustrating a beam profile observed by a beam profiler.

FIG. 5 is a top view schematically illustrating a configuration example of a laser apparatus according to a first embodiment.

FIG. 6 is a side view schematically illustrating a configuration example of a power oscillator according to the first embodiment.

FIG. 7 is a perspective view schematically illustrating a configuration example of a front-side observation device.

FIG. 8 is a perspective view schematically illustrating a configuration example of a rear-side observation device.

FIG. 9 is a diagram explaining an effect of a position adjusting stage provided in a rear-side optical system.

FIG. 10 is a diagram explaining an effect of an actuator provided in the rear-side optical system.

FIG. 11 is a flowchart illustrating an example of a procedure of optical path adjustment in the first embodiment.

FIG. 12 is a top view schematically illustrating a configuration example of a laser apparatus according to a second embodiment.

FIG. 13 is a perspective view schematically illustrating a configuration of an MO beam steering unit according to a modification.

FIG. 14 is a diagram schematically illustrating a configuration of a master oscillator according to the modification.

FIG. 15 is a diagram schematically illustrating a configuration example of an exposure apparatus.

### DESCRIPTION OF EMBODIMENTS

<Contents>
1. Comparative Example
   1.1 Configuration
   1.2 Operation
   1.3 Optical Path Adjustment
   1.4 Problem
2. First Embodiment
   2.1 Configuration
   2.2 Operation
   2.3 Optical Path Adjustment
   2.4 Effect
3. Second Embodiment
   3.1 Configuration
   3.2 Operation
   3.3 Optical Path Adjustment
   3.4 Effect
4. Modification of MO Beam Steering Unit
5. Modification of Master Oscillator
   5.1 Configuration
   5.2 Operation
   5.3 Others
6. Modification of Front-side Observation Device and Rear-side Observation Device
7. Electronic Device Manufacturing Method

Hereinafter, embodiments of the present disclosure will be described in detail with reference to the drawings. The embodiments described below show some examples of the present disclosure and do not limit contents of the present disclosure. In addition, all configurations and operations described in the embodiments are not necessarily essential as configurations and operations of the present disclosure. Here, the same components are denoted by the same reference numerals, and any redundant description thereof is omitted.

### 1. Comparative Example

The comparative example of the present disclosure is an example recognized by the applicant as known only by the applicant, and is not a publicly known example admitted by the applicant.

### 1.1 Configuration

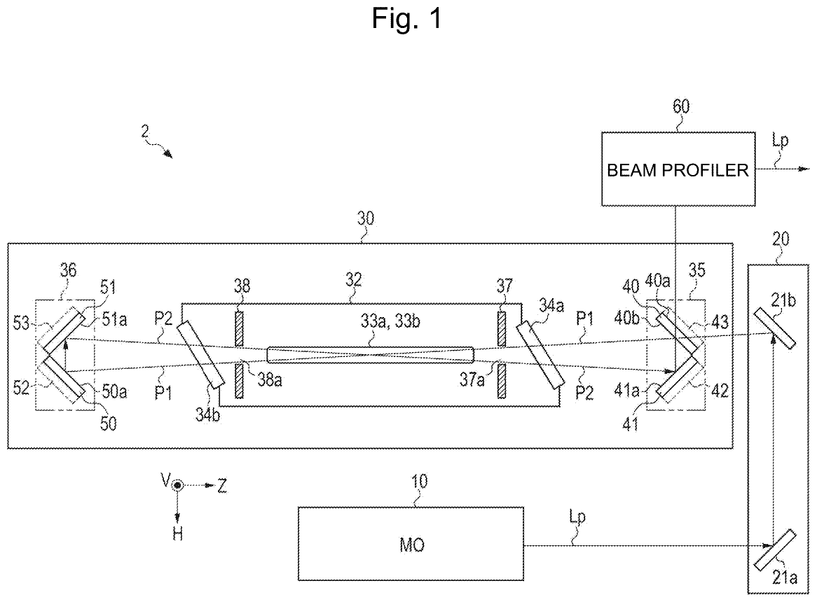

FIG. 1 schematically illustrates a configuration example of a laser apparatus 2 according to the comparative example. In FIG. 1, a height direction of the laser apparatus 2 is defined as a V-axis direction, a length direction is defined as a Z-axis direction, and a depth direction is defined as an H-axis direction. The V-axis direction may be parallel to a gravity direction, and a direction opposite to the gravity direction is referred to as a “+V-axis direction”. An output direction of a laser beam Lp output from the laser apparatus 2 is referred to as a “+Z-axis direction”. Further, a direction toward a front of a paper surface of FIG. 1 is referred to as a “+V-axis direction”.

The laser apparatus 2 includes a master oscillator (MO) 10, an MO beam steering unit 20, and a power oscillator (PO) 30. The master oscillator 10 is an example of an “oscillator” according to a technology of the present disclosure. The MO beam steering unit 20 is an example of a “beam steering device” according to the technology of the present disclosure. The power oscillator 30 is an example of an “amplifier” according to the technology of the present disclosure.

The MO beam steering unit 20 is disposed on an optical path of the laser beam Lp between the master oscillator 10 and the power oscillator 30, and enables adjustment of a position and an angle of an optical path of the laser beam Lp entering the power oscillator 30.

The MO beam steering unit 20 includes two high reflective mirrors 21a and 21b. The high reflective mirrors 21a and 21b are disposed such that the laser beam Lp output from the master oscillator 10 enters the power oscillator 30. The laser beam Lp output from the master oscillator 10 is a pulse laser beam. An unillustrated actuator for changing a posture is attached to each of the high reflective mirrors 21a and 21b. For example, the actuator enables tilt adjustment in left-right and up-down directions.

A high reflective mirror in the present disclosure is, for example, a planar mirror in which a high reflective film is formed on a surface of a substrate formed of synthetic quartz or calcium fluoride (CaF₂). The high reflective film is a dielectric multilayer film, for example, a film containing fluoride.

The power oscillator 30 includes a chamber 32, a front-side optical system 35, and a rear-side optical system 36. The front-side optical system 35 is disposed on a light entering side where the laser beam Lp enters the power oscillator 30 from the MO beam steering unit 20. The rear-side optical system 36 is disposed at a position facing the front-side optical system 35 with the chamber 32 interposed therebetween.

The chamber 32 is disposed on an optical path of a ring resonator. The chamber 32 is filled with a laser gas. The laser gas may include, for example, an Ar gas or a Kr gas as a rare gas, an F₂ gas as a halogen gas, and an Ne gas as a buffer gas.

The chamber 32 includes a pair of discharge electrodes 33a and 33b and two windows 34a and 34b through which the laser beam Lp is transmitted. The pair of discharge electrodes 33a and 33b are disposed to face each other in the V-axis direction. The windows 34a and 34b are disposed such that an incident angle of the laser beam Lp is close to a Brewster's angle. Further, the windows 34a and 34b are disposed such that a polarization state of the laser beam Lp is P polarization.

Inside the chamber 32, a slit member 37 having a slit 37a and a slit member 38 having a slit 38a are provided. The slit member 37 is disposed between the pair of discharge electrodes 33a and 33b and the window 34a so that the laser beam Lp passes through the slit 37a. The slit member 38 is disposed between the pair of discharge electrodes 33a and 33b and the window 34b so that the laser beam Lp passes through the slit 38a. The slit members 37 and 38 suppress stray light and prevent dust generated in a discharge space from adhering to the windows 34a and 34b.

The front-side optical system 35 includes an output coupling mirror 40 and a high reflective mirror 41. The output coupling mirror 40 is disposed on an optical path of the laser beam Lp entering from the MO beam steering unit 20 so that the laser beam Lp has a predetermined incident angle on the output coupling mirror 40.

The output coupling mirror 40 is, for example, a partial reflective mirror having a reflectance in a range of 10% to 30%. The output coupling mirror 40 has a first surface 40a and a second surface 40b that face each other. The first surface 40a and the second surface 40b are parallel to the V-axis direction, which is a discharge direction of the pair of discharge electrodes 33a and 33b.

The output coupling mirror 40 transmits a part of the laser beam Lp incident on the first surface 40a from the MO beam steering unit 20 and reflects the other part. Further, the output coupling mirror 40 transmits a part of the laser beam Lp incident on the second surface 40b from the high reflective mirror 41 and reflects the other part. A part of the laser beam Lp transmitted through the output coupling mirror 40 is output from the front-side optical system 35 to an outside of the power oscillator 30. A part of the laser beam Lp reflected by the second surface 40b of the output coupling mirror 40 enters the chamber 32.

The high reflective mirror 41 has a high reflective surface 41a on which a high reflective film is formed. The output coupling mirror 40 and the high reflective mirror 41 are disposed such that the second surface 40b and the high reflective surface 41a face each other at a predetermined angle. The high reflective mirror 41 reflects at the high reflective surface 41a, toward the second surface 40b of the output coupling mirror 40, the laser beam Lp incoming from the rear-side optical system 36 through the chamber 32.

Actuators 42 and 43 for changing postures are attached to the high reflective mirror 41 and the output coupling mirror 40, respectively. For example, the actuators 42 and 43 enable tilt adjustment in the left-right and up-down directions.

The rear-side optical system 36 includes a first high reflective mirror 50 and a second high reflective mirror 51. The first high reflective mirror 50 has a high reflective surface 50a on which a high reflective film is formed. The second high reflective mirror 51 has a high reflective surface 51a on which a high reflective film is formed. The high reflective surface 50a and the high reflective surface 51a are parallel to the V-axis direction. The first high reflective mirror 50 and the second high reflective mirror 51 are disposed such that the high reflective surface 50a and the high reflective surface 51a face each other at a predetermined angle.

The first high reflective mirror 50 reflects at the high reflective surface 50a, toward the second high reflective mirror 51, the laser beam Lp incoming from the front-side optical system 35 through the chamber 32. The second high reflective mirror 51 reflects at the high reflective surface 51a, toward the chamber 32, the laser beam Lp incoming from the first high reflective mirror 50.

The front-side optical system 35 and the rear-side optical system 36 configure a ring resonator including a first optical path P1 and a second optical path P2 that intersect between the pair of discharge electrodes 33a and 33b. The first optical path P1 and the second optical path P2 are close to each other in the discharge space between the pair of discharge electrodes 33a and 33b.

The first optical path P1 is formed by the output coupling mirror 40 and the first high reflective mirror 50. The second optical path P2 is formed by the second high reflective mirror 51 and the high reflective mirror 41. The first optical path P1 is an optical path through which the front-side optical system 35 outputs, toward the rear-side optical system 36, the laser beam Lp incoming from the master oscillator 10. The second optical path P2 is an optical path through which the rear-side optical system 36 outputs, toward the front-side optical system 35, the laser beam Lp incoming through the first optical path P1.

That is, the first optical path P1 is a forward path from the front-side optical system 35 to the rear-side optical system 36 via the chamber 32. The second optical path P2 is a return path from the rear-side optical system 36 to the front-side optical system 35 via the chamber 32. The first optical path P1 and the second optical path P2 are included in a plane orthogonal to the V-axis direction, which is the discharge direction by the pair of discharge electrodes 33a and 33b.

A beam profiler 60 configured to observe a beam profile of the laser beam Lp is provided in an optical path of the laser beam Lp output from the power oscillator 30. For example, the beam profiler 60 is formed of an ultraviolet light camera that images a beam profile of a laser beam Lp. The beam profiler 60 is configured to be retractable from the optical path of the laser beam Lp. The beam profiler 60 may be attachable and detachable to/from the power oscillator 30. In addition, the beam profiler 60 may include, instead of the ultraviolet light camera, a fluorescent screen that converts the laser beam Lp into visible light and a visible light camera that images the fluorescent screen.

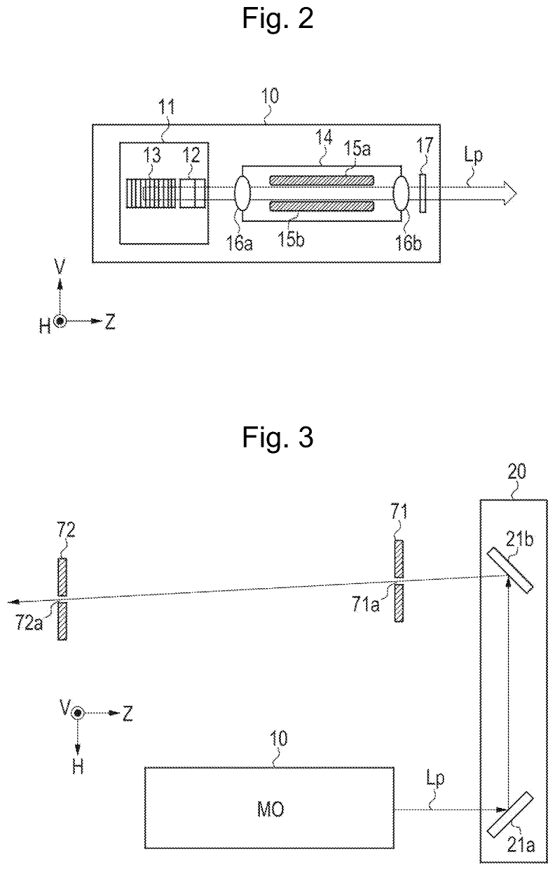

FIG. 2 schematically illustrates a configuration example of the master oscillator 10 according to the comparative example. The master oscillator 10 includes a line narrowing module 11, a chamber 14, and an output coupling mirror (output coupler: OC) 17.

The line narrowing module 11 includes a prism beam expander 12 for narrowing a spectral linewidth and a grating 13. The prism beam expander 12 and the grating 13 are disposed in Littrow arrangement such that an incident angle and a diffracting angle coincide with each other.

The output coupling mirror 17 is, for example, a reflective mirror having a reflectance in a range of 40% to 60%. The output coupling mirror 17 and the line narrowing module 11 constitute an optical resonator.

The chamber 14 is disposed on an optical path of the optical resonator. The chamber 14 includes a pair of discharge electrodes 15a and 15b, and two windows 16a and 16b through which the laser beam Lp is transmitted. The chamber 14 is filled with a laser gas.

The windows 16a and 16b are disposed such that the incident angle of the laser beam Lp is close to the Brewster's angle. The windows 16a and 16b are disposed such that the polarization state of the laser beam Lp is the P polarization.

### 1.2 Operation

When discharge occurs in the chamber 14 of the master oscillator 10, the laser gas is excited, and the laser beam Lp line-narrowed by the optical resonator formed of the output coupling mirror 17 and the line narrowing module 11 is output from the output coupling mirror 17. The laser beam Lp enters the front-side optical system 35 of the power oscillator 30 as seed light via the MO beam steering unit 20.

The laser beam Lp that has entered the front-side optical system 35 is transmitted through the output coupling mirror 40 and enters the inside of the ring resonator. The laser beam Lp that has transmitted through the output coupling mirror 40 travels along the first optical path P1 and enters the chamber 32. Discharge occurs in the discharge space in synchronization with timing at which the laser beam Lp enters the chamber 32. Consequently, the laser gas is excited and the laser beam Lp is amplified. The amplified laser beam Lp is output from the chamber 32, travels along the first optical path P1, and then enters the rear-side optical system 36.

The laser beam Lp that has entered the rear-side optical system 36 is reflected by the first high reflective mirror 50 and the second high reflective mirror 51 so that a traveling direction is turned back, and is output from the rear-side optical system 36. The laser beam Lp output from the rear-side optical system 36 travels along the second optical path P2 and enters the chamber 32. The laser beam Lp that has entered the chamber 32 is amplified again in the discharge space and is output from the chamber 32. The laser beam Lp output from the chamber 32 travels along the second optical path P2 and then enters the front-side optical system 35.

The laser beam Lp that has entered the front-side optical system 35 is reflected by the high reflective mirror 41 toward the output coupling mirror 40. A part of the laser beam Lp incident on the output coupling mirror 40 is transmitted through the output coupling mirror 40 and is output from the front-side optical system 35 to the outside of the power oscillator 30.

The remaining part of the laser beam Lp incident on the output coupling mirror 40 is reflected by the output coupling mirror 40 and is thus output from the front-side optical system 35 toward the chamber 32. That is, the traveling direction of the remaining part of the laser beam Lp is turned back in the front-side optical system 35. The laser beam Lp the traveling direction of which has been turned back travels along the first optical path P1 again and enters the chamber 32. In this way, a part of the laser beam Lp is repeatedly circulated in the ring resonator including the first optical path P1 and the second optical path P2. The laser beam Lp passes through the discharge space a plurality of times within a single discharge time period, and is thus amplified and oscillated.

The laser beam Lp output from the power oscillator 30 travels through the optical path in which the beam profiler 60 is disposed, and is output from the laser apparatus 2. While the laser apparatus 2 is operated, the beam profiler 60 is retracted from the optical path of the laser beam Lp output from the power oscillator 30.

### 1.3 Optical Path Adjustment

Next, optical path adjustment performed in a preparation stage before operating the laser apparatus 2 according to the comparative example will be described.

FIG. 3 schematically illustrates an initial state of the optical path adjustment according to the comparative example. First, an operator detaches the power oscillator 30 from the laser apparatus 2 in the preparation stage. Next, the operator disposes a pair of slit members 71 and 72 for adjustment at a fixed interval on an optical path of the laser beam Lp that is assumed to be output from the MO beam steering unit 20. The slit members 71 and 72 are formed with slits 71a and 72a, respectively.

Next, the operator operates the master oscillator 10 to output the laser beam Lp. The operator adjusts the postures of the high reflective mirrors 21a and 21b of the MO beam steering unit 20 so that the laser beam Lp output from the MO beam steering unit 20 passes through the slits 71a and 72a, respectively. As a result, the optical path adjustment of the laser beam Lp output from the MO beam steering unit 20 is completed.

The operator removes the slits 71a and 72a from the laser apparatus 2 in a state where the operation of the master oscillator 10 is stopped, and attaches the power oscillator 30 to the laser apparatus 2. Then, in a state where the master oscillator 10 and the power oscillator 30 are operated, the operator operates the actuators 42, 43, 52, and 53 while observing a beam profile by the beam profiler 60 to adjust the postures of the output coupling mirror 40 and the high reflective mirrors 41, 50, and 51. The actuator in the present disclosure is, for example, a mirror holder with a two-axis actuator.

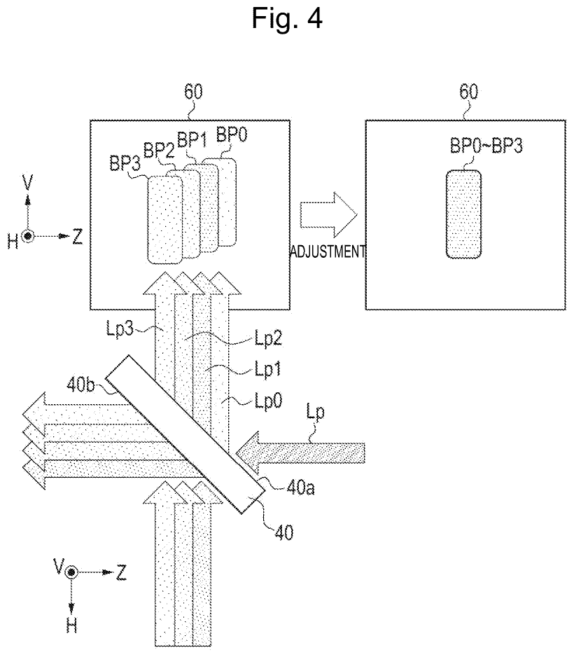

FIG. 4 schematically illustrates a beam profile observed by the beam profiler 60. In FIG. 4, reference character Lp0 represents the laser beam Lp incident on the output coupling mirror 40 from the MO beam steering unit 20 and is output from the power oscillator 30 by being partially reflected by the first surface 40a. Reference character Lp1 represents the laser beam Lp that is circulated in the ring resonator once and is output from the power oscillator 30. Reference character Lp2 represents the laser beam Lp that is circulated in the ring resonator twice and is output from the power oscillator 30. Reference character Lp3 represents the laser beam Lp that is circulated in the ring resonator three times and is output from the power oscillator 30.

In the present disclosure, in order to simplify explanation, it is assumed that four laser beams Lp0 to Lp3 differing in the number of circulations are output from the power oscillator 30 in response to the laser beam Lp for one pulse entering the power oscillator 30. In addition, when the four laser beams Lp0 to Lp3 do not need to be distinguished, they are simply referred to as the laser beam Lp.

Beam profiles BP0 to BP3 of the laser beams Lp0 to Lp3 are respectively observed by the beam profiler 60. The operator adjusts the postures of the output coupling mirror 40 and the high reflective mirrors 41, 50, and 51 so that the beam profiles BP0 to BP3 completely overlap with each other while observing an overlap degree of the beam profiles BP0 to BP3. As a result, the adjustment of the first optical path P1 and the second optical path P2 included in the ring resonator is completed.

### 1.4 Problem

In the power oscillator 30, amplification efficiency of the laser beam Lp changes in accordance with a relative positional relation between the discharge space and the first and second optical paths P1, P2 that intersect with each other. Therefore, it is desirable that the first optical path P1 and the second optical path P2 be as close as possible.

On the other hand, in order to turn back the traveling direction of the laser beam Lp in the front-side optical system 35 and the rear-side optical system 36, both the first optical path P1 and the second optical path P2 need to be separated from each other by a certain amount or more at both ends. For this purpose, it is necessary to increase a resonator length corresponding to a distance between the front-side optical system 35 and the rear-side optical system 36. In this way, since the power oscillator 30 has a long resonator length, high adjustment accuracy is required in order to perform the optical path adjustment without lowering the amplification efficiency.

In addition, in the ring resonator, the first optical path P1 and the second optical path P2 need to accurately pass through the slits 37a and 38a so that vignetting of the laser beam Lp does not occur in the slit members 37 and 38 disposed in the chamber 32. From this viewpoint as well, high adjustment accuracy is required for the optical path adjustment.

However, in an optical path adjusting method according to the comparative example, the operator cannot accurately recognize whether or not the first optical path P1 and the second optical path P2 in the chamber 32 are optimal just by performing the optical path adjustment so that the beam profiles BP0 to BP3 overlap with each other. Therefore, it is difficult for the operator to determine the posture of which mirror among the output coupling mirror 40 and the high reflective mirrors 41, 50, and 51 should be adjusted when the optical path adjustment is to be performed so that the beam profiles BP0 to BP3 completely overlap with each other. Depending on the mirror to be adjusted, even when the beam profiles BP0 to BP3 are made to completely overlap with each other, vignetting of the laser beam Lp due to the slits 37a and 38a may occur, and energy of the laser beam Lp output from the power oscillator 30 may decrease.

Further, in the optical path adjusting method according to the comparative example, since it is necessary to detach the power oscillator 30 from the laser apparatus 2 to perform the optical path adjustment, it takes a long time to adjust the optical path.

As described above, in the laser apparatus 2 including the power oscillator 30 including the ring resonator, it is required to accurately perform the optical path adjustment without lowering the amplification efficiency, and to shorten the time required for the optical path adjustment.

### 2. First Embodiment

### 2.1 Configuration

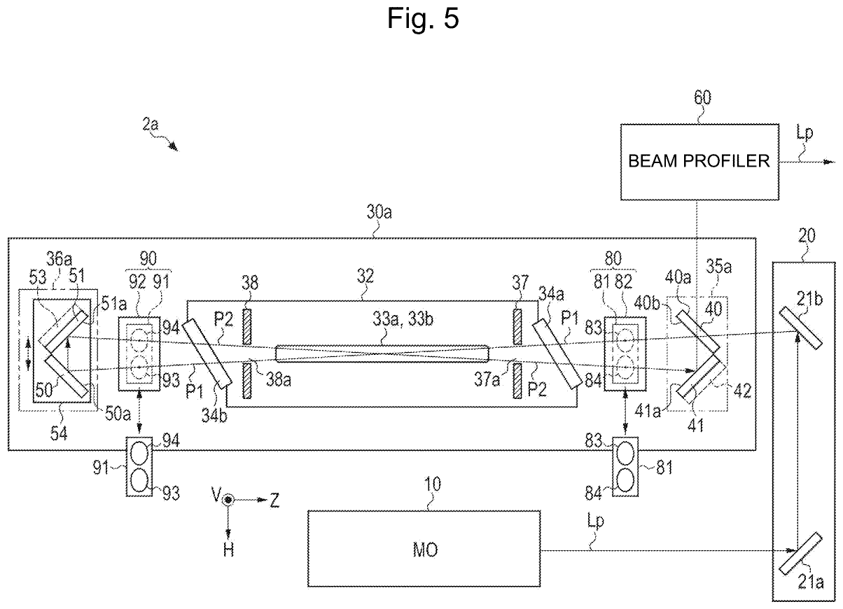

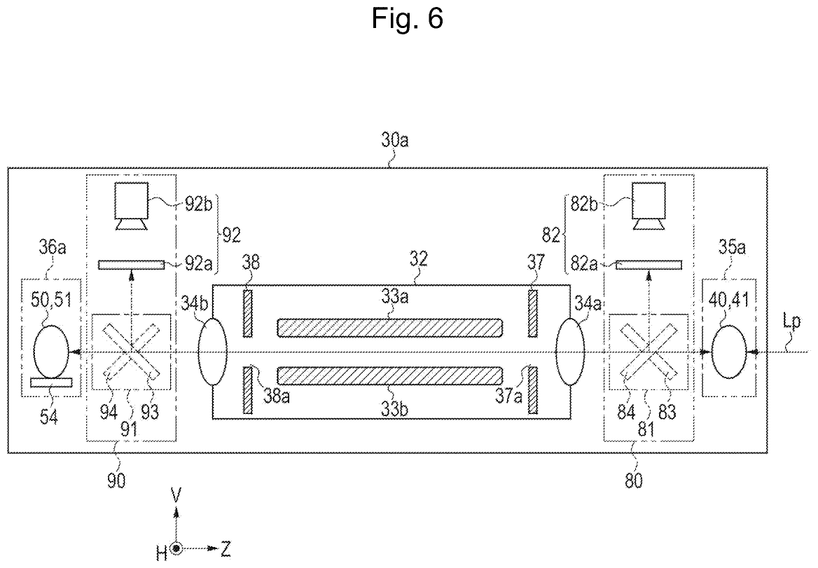

FIG. 5 schematically illustrates a configuration example of a laser apparatus 2a according to a first embodiment of the present disclosure. FIG. 6 schematically illustrates a configuration example of a power oscillator 30a according to the first embodiment. FIG. 5 is a diagram viewing the laser apparatus 2a from the V-axis direction. FIG. 6 is a diagram viewing the power oscillator 30a from the H-axis direction. The laser apparatus 2a differs from the laser apparatus 2 according to the comparative example only in the configuration of the power oscillator 30a.

In FIG. 5, the power oscillator 30a is provided with a front-side observation device 80 and a rear-side observation device 90 in addition to the chamber 32, a front-side optical system 35a, and a rear-side optical system 36a. The front-side observation device 80 enables observation of the first optical path P1 and the second optical path P2 between the front-side optical system 35a and the chamber 32. The rear-side observation device 90 enables observation of the first optical path P1 and the second optical path P2 between the rear-side optical system 36a and the chamber 32.

The front-side observation device 80 includes a front-side mirror unit 81 and a front-side beam profiler 82. The front-side mirror unit 81 includes a front-side first mirror 83 and a front-side second mirror 84. The front-side first mirror 83 is a partial reflective mirror that is disposed in the first optical path P1 and partially reflects the laser beam Lp incoming along the first optical path P1. The front-side second mirror 84 is a high reflective mirror that is disposed in the second optical path P2 and highly reflects the laser beam Lp incoming along the second optical path P2. For example, the front-side first mirror 83 is a half mirror that reflects about 50% of the incident laser beam Lp and transmits the rest. The front-side mirror unit 81 is disposed on an unillustrated moving stage, and is configured to be retractable from the first optical path P1 and the second optical path P2.

The rear-side observation device 90 includes a rear-side mirror unit 91 and a rear-side beam profiler 92. The rear-side mirror unit 91 includes a rear-side first mirror 93 and a rear-side second mirror 94. The rear-side first mirror 93 is a partial reflective mirror that is disposed in the first optical path P1 and partially reflects the laser beam Lp incoming along the first optical path P1. The rear-side second mirror 94 is a high reflective mirror that is disposed in the second optical path P2 and highly reflects the laser beam Lp incoming along the second optical path P2. For example, the rear-side first mirror 93 is a half mirror that reflects about 50% of the incident laser beam Lp and transmits the rest. The rear-side mirror unit 91 is disposed on an unillustrated moving stage, and is configured to be retractable from the first optical path P1 and the second optical path P2.

Each moving stage on which the front-side mirror unit 81 or the rear-side mirror unit 91 is disposed may be a linear stage or a rotating stage.

In FIG. 6, the front-side first mirror 83 is disposed so that the laser beam Lp traveling in the first optical path P1 has an incident angle of 45° on the front-side first mirror 83 and a part of the incident laser beam Lp is reflected in the V-axis direction. The front-side second mirror 84 is disposed so that the laser beam Lp traveling in the second optical path P2 has an incident angle of 45° on the front-side second mirror 84 and the incident laser beam Lp is highly reflected in the V-axis direction.

The rear-side first mirror 93 is disposed so that the laser beam Lp traveling in the first optical path P1 has an incident angle of 45° on the rear-side first mirror 93 and a part of the incident laser beam Lp is reflected in the V-axis direction. The rear-side second mirror 94 is disposed so that the laser beam Lp traveling in the second optical path P2 has an incident angle of 45° on the rear-side second mirror 94 and the incident laser beam Lp is highly reflected in the V-axis direction.

The front-side beam profiler 82 includes a front-side screen 82a and a front-side camera 82b. The front-side screen 82a is a fluorescent screen that converts light in an ultraviolet light range into visible light. As the fluorescent screen, for example, functional fluorescent glass such as Lumilass can be used. The front-side screen 82a is disposed in such a manner that allows for vertical incidence of the reflected light from the front-side first mirror 83 and the reflected light from the front-side second mirror 84. The front-side camera 82b is a visible light camera including an image sensor of a CMOS (complementary metal-oxide semiconductor) type, a CCD (charge-coupled device) type, or the like, and images a pair of bright spots generated by the reflected light incident on the front-side screen 82a.

The rear-side beam profiler 92 includes a rear-side screen 92a and a rear-side camera 92b. The rear-side screen 92a is a fluorescent screen that converts light in an ultraviolet light range into visible light. As the fluorescent screen, for example, functional fluorescent glass such as Lumilass can be used. The rear-side screen 92a is disposed in such a manner that allows for vertical incidence of the reflected light from the rear-side first mirror 93 and the reflected light from the rear-side second mirror 94. The rear-side camera 92b is a visible light camera including an image sensor of the CMOS type, the CCD type, or the like, and images a pair of bright spots generated by the reflected light incident on the rear-side screen 92a.

Unlike the front-side mirror unit 81 and the rear-side mirror unit 91, the front-side beam profiler 82 and the rear-side beam profiler 92 are fixed to the chamber 32.

An image processor that performs image processing on an image captured by each of the front-side beam profiler 82 and the rear-side beam profiler 92, and a display that displays the image on which the image processing has been performed may be provided. In addition, it is preferable that positions and an interval of the pair of bright spots in each of the front-side screen 82a and the rear-side screen 92a are measured by the image processing, and measurement results are displayed on the display.

In the first embodiment, of the output coupling mirror 40 and the high reflective mirror 41 included in the front-side optical system 35a, only the high reflective mirror 41 is provided with an actuator 42. In addition, of the first high reflective mirror 50 and the second high reflective mirror 51 included in the rear-side optical system 36a, only the second high reflective mirror 51 is provided with an actuator 53. The actuator 53 corresponds to a “first actuator” according to the technology of the present disclosure.

In the first embodiment, the first high reflective mirror 50 and the second high reflective mirror 51 included in the rear-side optical system 36a are disposed on a position adjusting stage 54. The position adjusting stage 54 moves the first high reflective mirror 50 and the second high reflective mirror 51 in the H-axis direction, which is a direction orthogonal to a longitudinal direction of the pair of discharge electrodes 33a and 33b and the discharge direction.

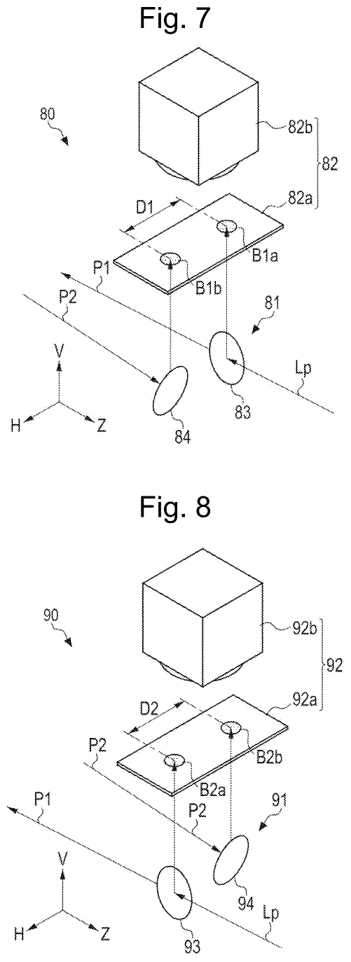

FIG. 7 schematically illustrates a configuration example of the front-side observation device 80. The front-side screen 82a is disposed to be parallel to the Z-axis direction and the H-axis direction. The front-side camera 82b images a bright spot B1a generated by the reflected light from the front-side first mirror 83 and a bright spot B1b generated by the reflected light from the front-side second mirror 84, on the front-side screen 82a.

FIG. 8 schematically illustrates a configuration example of the rear-side observation device 90. The rear-side screen 92a is disposed to be parallel to the Z-axis direction and the H-axis direction. The rear-side camera 92b images a bright spot B2a generated by the reflected light from the rear-side first mirror 93 and a bright spot B2b generated by the reflected light from the rear-side second mirror 94, on the rear-side screen 92a.

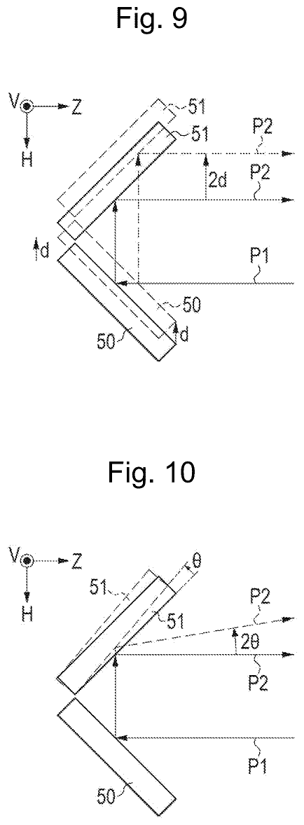

FIG. 9 explains an effect of the position adjusting stage 54 provided in the rear-side optical system 36a illustrated in FIG. 5. When the position adjusting stage 54 moves the first high reflective mirror 50 and the second high reflective mirror 51 in the H-axis direction, the second optical path P2 is translated in the H-axis direction. When the position adjusting stage 54 moves the first high reflective mirror 50 and the second high reflective mirror 51 for a distance d, the second optical path P2 moves for a distance 2d. In this way, a position of the second optical path P2 can be adjusted by the position adjusting stage 54.

FIG. 10 explains an effect of the actuator 53 provided in the rear-side optical system 36a illustrated in FIG. 5. When the actuator 53 changes the posture of the second high reflective mirror 51, an angle of the second optical path P2 changes. When the actuator 53 rotates the second high reflective mirror 51 by an angle θ about a V axis, the second optical path P2 is rotated by an angle 20 about the V axis. In this way, the angle of the second optical path P2 can be adjusted by the actuator 53.

### 2.2 Operation

The operation of the laser apparatus 2a according to the first embodiment is same as that of the laser apparatus 2 according to the comparative example. During the operation of the laser apparatus 2a, the front-side mirror unit 81 and the rear-side mirror unit 91 are retracted from the first optical path P1 and the second optical path P2, and the beam profiler 60 is retracted from an optical path of the laser beam Lp output from the power oscillator 30a.

### 2.3 Optical Path Adjustment

Next, the optical path adjustment performed in the preparation stage before operating the laser apparatus 2a according to the first embodiment will be described.

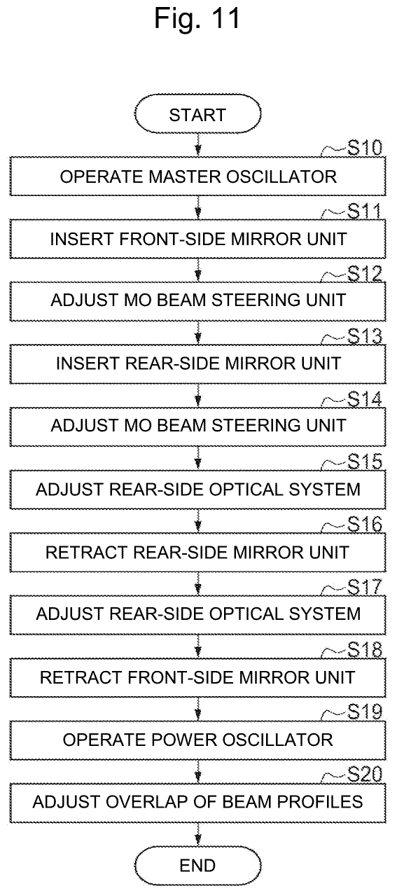

FIG. 11 illustrates an example of a procedure of the optical path adjustment according to the first embodiment. In the optical path adjustment in the first embodiment, it is not necessary to perform the adjustment using the pair of slit members 71 and 72 while the power oscillator 30a is detached from the laser apparatus 2a as in the comparative example. First, an operator operates the master oscillator 10 to output the laser beam Lp while the power oscillator 30a is attached to the laser apparatus 2a (step S10). At this time, the front-side mirror unit 81 and the rear-side mirror unit 91 are retracted from the first optical path P1 and the second optical path P2. The beam profiler 60 is inserted into the optical path of the laser beam Lp output from the power oscillator 30a.

The operator inserts the front-side mirror unit 81 into the first optical path P1 and the second optical path P2 (step S11).

The operator adjusts the MO beam steering unit 20 while observing the bright spots B1a and B1b using the front-side observation device 80 (step S12). For example, the operator adjusts the positions and the angles of the first optical path P1 and the second optical path P2 by changing the postures of the high reflective mirrors 21a and 21b so that the bright spots B1a and B1b are at predetermined positions. Here, the predetermined positions are positions of the bright spots B1a and B1b observed when the first optical path P1 and the second optical path P2 are in an appropriate state of passing through the discharge space and also passing through the slits 37a and 38a. The operator adjusts the MO beam steering unit 20 so that the bright spots B1a and B1b coincide with a pair of markers or the like indicating the predetermined positions on the display or the front-side screen 82a.

Next, the operator inserts the rear-side mirror unit 91 into the first optical path P1 and the second optical path P2 (step S13). Thus, the front-side mirror unit 81 and the rear-side mirror unit 91 are inserted into the first optical path P1 and the second optical path P2. The laser beam Lp transmitted through the front-side first mirror 83 of the front-side mirror unit 81 travels in the first optical path P1 and is incident on the rear-side first mirror 93 of the rear-side mirror unit 91.

The operator adjusts the MO beam steering unit 20 while observing the bright spots B2a and B2b using the rear-side observation device 90 (step S14). For example, the operator confirms whether or not the bright spots B2a and B2b are at predetermined positions, and when they are not at the predetermined positions, adjusts the positions and the angles of the first optical path P1 and the second optical path P2 by changing the postures of the high reflective mirrors 21a and 21b, as in step S12. Here, the predetermined positions are positions of the bright spots B2a and B2b observed when the first optical path P1 and the second optical path P2 are in the appropriate state. The operator adjusts the MO beam steering unit 20 so that the bright spots B2a and B2b coincide with a pair of markers or the like indicating the predetermined positions on the display or the rear-side screen 92a.

In addition, in step S14, the operator confirms whether or not the bright spots B2a and B2b are circular. When the vignetting of the laser beam Lp by the slit members 37 and 38 occurs, circularity of the bright spot B2a decreases. When the bright spots B2a and B2b are not circular, the positions and the angles of the first optical path P1 and the second optical path P2 are adjusted by changing the postures of the high reflective mirrors 21a and 21b.

Further, the operator adjusts the rear-side optical system 36a while observing the bright spots B2a and B2b using the rear-side observation device 90 (step S15). For example, the operator confirms whether or not a distance D2 (see FIG. 8) between the bright spots B2a and B2b is a predetermined distance, and when the distance D2 is not the predetermined distance, makes the distance D2 be the predetermined distance by translating the second optical path P2 by the position adjusting stage 54. Here, the predetermined distance is a distance between the bright spots B2a and B2b observed when the first optical path P1 and the second optical path P2 are in the appropriate state.

Next, the operator retracts the rear-side mirror unit 91 from the first optical path P1 and the second optical path P2 (step S16).

The operator adjusts the rear-side optical system 36a while observing the bright spots B1a and B1b using the front-side observation device 80 (step S17). For example, the operator confirms whether or not a distance D1 (see FIG. 7) between the bright spots B1a and B1b is a predetermined distance, and when the distance D1 is not the predetermined distance, makes the distance D1 be the predetermined distance by changing the angle of the second optical path P2 by the actuator 53. Here, the predetermined distance is a distance between the bright spots B1a and B1b observed when the first optical path P1 and the second optical path P2 are in the appropriate state.

Next, the operator retracts the front-side mirror unit 81 from the first optical path P1 and the second optical path P2 (step S18). The operator operates the power oscillator 30a (step S19). As a result, the amplified laser beam Lp is output from the power oscillator 30a.

Then, the operator adjusts overlap of the beam profiles BP0 to BP3 (see FIG. 4) using the beam profiler 60 (step S20). Specifically, the operator changes the posture of the high reflective mirror 41 using the actuator 42 so as to maximize the overlap degree of the beam profiles BP0 to BP3. Thus, the optical path adjustment is ended.

The optical path adjusting method of the present disclosure includes adjusting the rear-side optical system 36a through observation of the first optical path P1 and the second optical path P2 using the rear-side observation device 90 (step S15), adjusting the rear-side optical system 36a through observation of the first optical path P1 and the second optical path P2 using the front-side observation device 80 (step S17), and adjusting the front-side optical system 35a through observation of the optical path of the laser beam Lp output from the power oscillator 30a (step S20).

Further, the optical path adjusting method of the present disclosure includes adjusting the MO beam steering unit 20 through observation of the first optical path P1 and the second optical path P2 using the front-side observation device 80 and the rear-side observation device 90 (steps S12 and S14).

### 2.4 Effect

In the present embodiment, the operator can accurately recognize whether or not the first optical path P1 and the second optical path P2 are optimal by using the front-side observation device 80 and the rear-side observation device 90. Therefore, the optical path adjustment can be accurately performed without lowering the amplification efficiency. Further, in the present embodiment, since it is not necessary to detach the power oscillator 30a from the laser apparatus 2a to perform the optical path adjustment as in the comparative example, it is possible to shorten the time required for the optical path adjustment.

### 3. Second Embodiment

### 3.1 Configuration

Next, a laser apparatus 2b according to a second embodiment of the present disclosure will be described. Hereinafter, differences from the configuration of the laser apparatus 2a according to the first embodiment will be described.

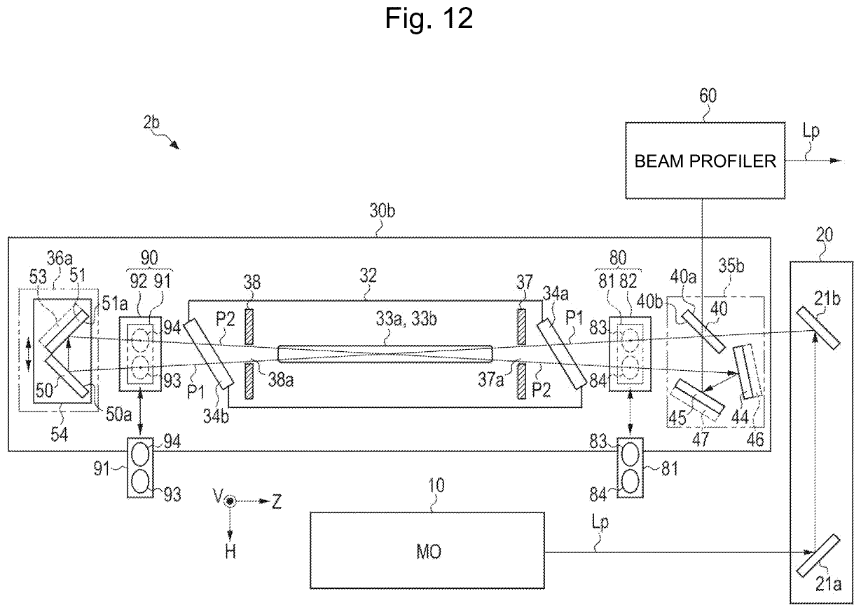

FIG. 12 schematically illustrates a configuration example of the laser apparatus 2b according to the second embodiment. The laser apparatus 2b differs from the configuration of the laser apparatus 2a according to the first embodiment only in the configuration of a power oscillator 30b. In the power oscillator 30b, a configuration of a front-side optical system 35b differs from the configuration of the front-side optical system 35a according to the first embodiment. The other configuration of the power oscillator 30b is the same as that of the power oscillator 30a according to the first embodiment.

The front-side optical system 35b includes the output coupling mirror 40, a third high reflective mirror 44, and a fourth high reflective mirror 45. The configuration of the output coupling mirror 40 is the same as that in the first embodiment. The third high reflective mirror 44 is disposed so as to reflect the laser beam Lp that travels in the second optical path P2 and enters the front-side optical system 35b toward the fourth high reflective mirror 45. The fourth high reflective mirror 45 is disposed so as to reflect the laser beam Lp incoming from the third high reflective mirror 44 toward the second surface 40b of the output coupling mirror 40.

The output coupling mirror 40 transmits a part of the laser beam Lp incident on the second surface 40b from the fourth high reflective mirror 45, and reflects the other part to make it travel along the first optical path P1.

Actuators 46 and 47 for changing the postures are attached respectively to the third high reflective mirror 44 and the fourth high reflective mirror 45. For example, the actuators 46 and 47 enable tilt adjustment in the left-right and up-down directions. By changing the postures of the third high reflective mirror 44 and the fourth high reflective mirror 45 using the actuators 46 and 47, the position and the angle of an optical path of the laser beam Lp output from the power oscillator 30b can be adjusted. The actuator 46 corresponds to a “second actuator” according to the technology of the present disclosure. The actuator 47 corresponds to a “third actuator” according to the technology of the present disclosure.

In the first embodiment, the ring resonator is formed of four mirrors that are the output coupling mirror 40, the high reflective mirror 41, the first high reflective mirror 50, and the second high reflective mirror 51. In contrast, in the second embodiment, the ring resonator is formed of five mirrors that are the output coupling mirror 40, the first high reflective mirror 50, the second high reflective mirror 51, the third high reflective mirror 44, and the fourth high reflective mirror 45.

### 3.2 Operation

The operation of the laser apparatus 2b according to the second embodiment is the same as the operation of the laser apparatus 2a according to the first embodiment, except that the laser beam Lp that has entered the front-side optical system 35b is reflected by the third high reflective mirror 44 and the fourth high reflective mirror 45 and is then incident on the output coupling mirror 40.

In the present embodiment, the laser beam Lp that has entered the front-side optical system 35b from the chamber 32 is reflected by the third high reflective mirror 44 and the fourth high reflective mirror 45, and is incident on the output coupling mirror 40. A part of the laser beam Lp incident on the output coupling mirror 40 is transmitted through the output coupling mirror 40 and is output from the front-side optical system 35b to the outside of the power oscillator 30b. The remaining part of the laser beam Lp incident on the output coupling mirror 40 is reflected by the output coupling mirror 40 and is thus output from the front-side optical system 35b toward the chamber 32.

### 3.3 Optical Path Adjustment

The procedure of the optical path adjustment according to the second embodiment is basically the same as that of the first embodiment. However, in the present embodiment, in step S20 illustrated in FIG. 11, the operator changes the postures of the third high reflective mirror 44 and the fourth high reflective mirror 45 using the actuators 46 and 47 so that the overlap degree of the beam profiles BP0 to BP3 becomes largest.

### 3.4 Effect

In the present embodiment, since the ring resonator is formed of the five mirrors, the beam profile is mirror-inverted every time the laser beam Lp is circulated in the ring resonator. That is, since the beam profile of the laser beam Lp output from the power oscillator 30b is mirror-inverted with every one circulation, spatial coherence of the laser beam Lp is reduced. Thus, when the laser apparatus 2b is used as a light source for exposure, speckles on a reticle is suppressed.

In addition, even when angle deviation is generated in the five mirrors constituting the ring resonator, since the beam profile of the laser beam Lp is mirror-inverted with every one circulation, there is an advantage that accumulation of angle deviation components of the individual mirrors is suppressed.

Further, in the present embodiment, the position and the angle of the laser beam Lp output from the power oscillator 30b can be adjusted using the two mirrors that are the third high reflective mirror 44 and the fourth high reflective mirror 45. Therefore, in the present embodiment, the overlap of the beam profiles BP0 to BP3 can be more accurately adjusted.

### 4. Modification of MO Beam Steering Unit

Next, a modification of the MO beam steering unit 20 will be described. The MO beam steering unit 20 according to the first and second embodiments can be variously modified.

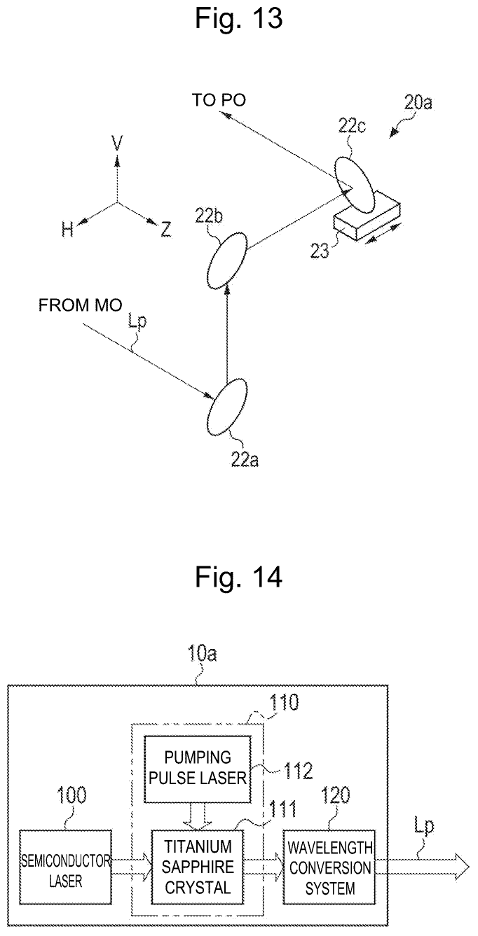

FIG. 13 schematically illustrates a configuration of an MO beam steering unit 20a according to the modification. The MO beam steering unit 20a includes three high reflective mirrors 22a, 22b, and 22c and a position adjusting stage 23. An unillustrated actuator for changing the posture is attached to each of the high reflective mirrors 22a and 22b. For example, the actuator enables tilt adjustment in the left-right and up-down directions.

The high reflective mirror 22c is disposed on the position adjusting stage 23. The position adjusting stage 23 moves the high reflective mirror 22c in the H-axis direction.

The high reflective mirror 22a is disposed at a position where the laser beam Lp output from the master oscillator 10 is incident on the high reflective mirror 22a, and highly reflects the laser beam Lp in the V-axis direction. The high reflective mirror 22b is disposed at a position where the laser beam Lp highly reflected by the high reflective mirror 22a is incident on the high reflective mirror 22b, and highly reflects the laser beam Lp in the H-axis direction. The high reflective mirror 22c is disposed at a position where the laser beam Lp highly reflected by the high reflective mirror 22b is incident on the high reflective mirror 22c, and highly reflects the laser beam Lp toward the power oscillator in the Z-axis direction.

By changing the postures of the high reflective mirrors 22a and 22b by the actuators, the angle of the first optical path P1 can be adjusted. Further, the position of the first optical path P1 can be adjusted by moving the high reflective mirror 22c by the position adjusting stage 23.

By using the MO beam steering unit 20a of the present modification instead of the MO beam steering unit 20 of the first and second embodiments, it is possible to accurately adjust the position and the angle of the first optical path P1 in steps S12 and S14 illustrated in FIG. 11.

The MO beam steering unit in the present disclosure may be any device that includes at least two mirrors and enables adjustment of the position and the angle of the optical path of the laser beam Lp entering the power oscillator.

### 5. Modification of Master Oscillator

Next, a modification of the master oscillator 10 will be described. In the first and second embodiments, while the laser apparatuses 2a and 2b each include the master oscillator 10 formed of an excimer laser apparatus, the master oscillator 10 can be variously modified.

### 5.1 Configuration

FIG. 14 schematically illustrates a configuration of a master oscillator 10a according to the modification. The master oscillator 10a is a solid-state laser device, and includes a semiconductor laser 100 that outputs seed light, a titanium sapphire amplifier 110 that amplifies the seed light, and a wavelength conversion system 120.

The semiconductor laser 100 is a distributed feedback type semiconductor laser that outputs a CW (continuous wave) laser beam having a wavelength of 773.6 nm as the seed light. By changing temperature setting of the semiconductor laser 100, an oscillation wavelength can be changed.

The titanium sapphire amplifier 110 includes a titanium sapphire crystal 111 and a pumping pulse laser 112. The titanium sapphire crystal 111 is disposed on an optical path of the seed light. The pumping pulse laser 112 is a laser apparatus that outputs second harmonic wave light of a YLF laser.

The wavelength conversion system 120 generates fourth harmonic light, and includes an LBO (LiB₃O₅) crystal and a KBBF (KBe₂BO₃F₂) crystal. Each crystal is disposed on an unillustrated rotating stage, and is configured to change an incident angle of the seed light with respect to each crystal.

### 5.2 Operation

In the titanium sapphire amplifier 110, the pumping pulse laser 112 converts the CW laser beam as the seed light input to the titanium sapphire crystal 111 into a pulse laser beam based on a trigger signal input from an unillustrated control unit, and outputs the pulse laser beam. The pulse laser beam output from the titanium sapphire amplifier 110 is input to the wavelength conversion system 120. The wavelength conversion system 120 wavelength-converts the input pulse laser beam having a wavelength of 773.6 nm into a pulse laser beam having a wavelength of 193.4 nm, and outputs the pulse laser beam as the laser beam Lp toward the MO beam steering unit.

In the present modification, the power oscillator is an ArF excimer amplifier, and amplifies the laser beam Lp having a wavelength of 193.4 nm input from the MO beam steering unit.

### 5.3 Others

The master oscillator 10a may be a solid-state laser device that outputs a pulse laser beam having a wavelength of 248.4 nm, and the power oscillator may be a KrF excimer amplifier. In this case, the semiconductor laser 100 outputs a CW laser beam having a wavelength of 745.2 nm, and the titanium sapphire amplifier 110 converts the CW laser beam input from the semiconductor laser 100 into a pulse laser beam and outputs the pulse laser beam. Here, the wavelength conversion system 120 generates third harmonic light, and includes an LBO crystal and a CLBO (CsLiB₆O₁₀) crystal. The wavelength conversion system 120 outputs a pulse laser beam having a wavelength of 248.4 nm as the laser beam Lp by generating the second harmonic light in the LBO crystal and generating the third harmonic light in the CLBO crystal.

### 6. Modification of Front-Side Observation Device and Rear-Side Observation Device

The front-side observation device 80 is not limited to the configuration in which the front-side mirror unit 81 is retractable from the first optical path P1 and the second optical path P2, and the front-side mirror unit 81 may be fixed to the first optical path P1 and the second optical path P2. Similarly, the rear-side observation device 90 is not limited to the configuration in which the rear-side mirror unit 91 is retractable from the first optical path P1 and the second optical path P2, and the rear-side mirror unit 91 may be fixed to the first optical path P1 and the second optical path P2. That is, the front-side mirror unit 81 and the rear-side mirror unit 91 may be disposed in the first optical path P1 and the second optical path P2 during the operation of the laser apparatuses 2a and 2b. In this case, the front-side second mirror 84 and the rear-side second mirror 94 disposed in the second optical path P2 each may be a partial reflective mirror so that the laser beam Lp is circulated in the ring resonator. Further, in this case, it is preferable that the front-side first mirror 83, the front-side second mirror 84, the rear-side first mirror 93, and the rear-side second mirror 94 are partial reflective mirrors each having a reflectance of 1% or less.

### 7. Electronic Device Manufacturing Method

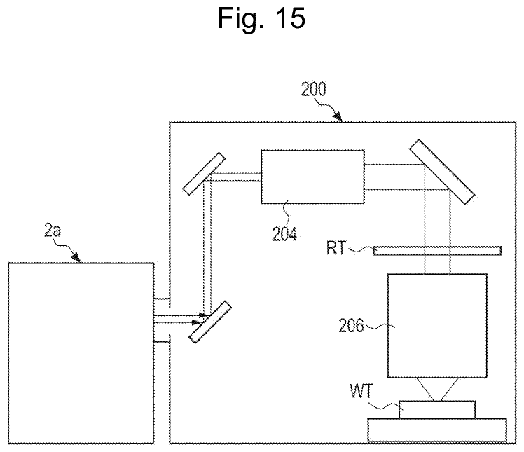

FIG. 15 schematically illustrates a configuration example of an exposure apparatus 200. The exposure apparatus 200 includes an illumination optical system 204 and a projection optical system 206. For example, the illumination optical system 204 illuminates a reticle pattern of an unillustrated reticle disposed on a reticle stage RT by the laser beam Lp that has entered from the laser apparatus 2a. The projection optical system 206 performs reduction projection of the laser beam Lp transmitted through the reticle and forms an image on an unillustrated workpiece disposed on a workpiece table WT. The workpiece is a photosensitive substrate such as a semiconductor wafer on which photoresist is applied.

The exposure apparatus 200 synchronously translates the reticle stage RT and the workpiece table WT to expose the workpiece to the laser beam Lp reflecting the reticle pattern. After the reticle pattern is transferred onto the semiconductor wafer by an exposure process described above, a semiconductor device can be manufactured through a plurality of processes. The semiconductor device is an example of an “electronic device” in the present disclosure.

Note that the laser apparatus that outputs the laser beam Lp to the exposure apparatus 200 may be any of the laser apparatuses according to the embodiments and modifications.

The description above is intended to be illustrative and the present disclosure is not limited thereto. Therefore, it would be obvious to those skilled in the art that various modifications to the individual embodiments of the present disclosure would be possible without departing from the spirit and the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.”

What is claimed is:

1. A laser apparatus comprising:
an oscillator configured to output a laser beam;
an amplifier configured to amplify the laser beam in a chamber including a pair of discharge electrodes;
a front-side optical system and a rear-side optical system disposed at positions facing each other across the chamber and constituting a ring resonator including a first optical path and a second optical path intersecting between the pair of discharge electrodes;
a front-side observation device that allows for observation of the first optical path and the second optical path between the front-side optical system and the chamber; and
a rear-side observation device that allows for observation of the first optical path and the second optical path between the rear-side optical system and the chamber,
the first optical path being an optical path through which the front-side optical system outputs, toward the rear-side optical system, the laser beam incoming from the oscillator,
the second optical path being an optical path through which the rear-side optical system outputs, toward the front-side optical system, the laser beam incoming through the first optical path.

2. The laser apparatus according to claim 1, wherein
the front-side observation device includes:
a front-side first mirror disposed in the first optical path;
a front-side second mirror disposed in the second optical path;
a front-side screen on which reflected light of the laser beam from the front-side first mirror and the front-side second mirror is incident; and
a front-side camera configured to image the front-side screen, and
the rear-side observation device includes:
a rear-side first mirror disposed in the first optical path;
a rear-side second mirror disposed in the second optical path;
a rear-side screen on which reflected light of the laser beam from the rear-side first mirror and the rear-side second mirror is incident; and
a rear-side camera configured to image the rear-side screen.

3. The laser apparatus according to claim 2, wherein
the front-side first mirror and the front-side second mirror are retractable from the first optical path and the second optical path between the front-side optical system and the chamber, and
the rear-side first mirror and the rear-side second mirror are retractable from the first optical path and the second optical path between the rear-side optical system and the chamber.

4. The laser apparatus according to claim 3, wherein
the front-side first mirror and the rear-side first mirror are partial reflective mirrors that partially reflect the laser beam incoming along the first optical path, and
the front-side second mirror and the rear-side second mirror are high reflective mirrors that highly reflect the laser beam incoming along the second optical path.

5. The laser apparatus according to claim 2, wherein
the front-side screen and the rear-side screen are fluorescent screens.

6. The laser apparatus according to claim 3, wherein
the front-side camera images a pair of bright spots generated on the front-side screen, and
the rear-side camera images a pair of bright spots generated on the rear-side screen.

7. The laser apparatus according to claim 1, wherein
the rear-side optical system includes a first high reflective mirror configured to reflect the laser beam incoming through the first optical path, and a second high reflective mirror configured to reflect the laser beam reflected by the first high reflective mirror to make the laser beam travel along the second optical path.

8. The laser apparatus according to claim 7, wherein
the first optical path and the second optical path are included in a plane orthogonal to a discharge direction by the pair of discharge electrodes, and
the rear-side optical system includes a position adjusting stage configured to move the first high reflective mirror and the second high reflective mirror in a direction orthogonal to a longitudinal direction of the pair of discharge electrodes and the discharge direction.

9. The laser apparatus according to claim 8, wherein
the rear-side optical system includes a first actuator configured to change a posture of the second high reflective mirror.

10. The laser apparatus according to claim 1, further comprising
a beam steering device disposed on an optical path of the laser beam between the oscillator and the amplifier, and configured to adjust an optical path of the laser beam entering the amplifier.

11. The laser apparatus according to claim 10, wherein
the beam steering device includes at least two mirrors, and enables adjustment of a position and an angle of the optical path of the laser beam entering the amplifier.

12. The laser apparatus according to claim 1, further comprising
a beam profiler that allows for observation of an optical path of the laser beam output from the amplifier.

13. The laser apparatus according to claim 1, wherein
the front-side optical system includes an output coupling mirror, a third high reflective mirror, and a fourth high reflective mirror, and
the output coupling mirror transmits the laser beam incoming from the oscillator to make the laser beam travel along the first optical path.

14. The laser apparatus according to claim 13, wherein
the third high reflective mirror reflects, toward the fourth high reflective mirror, the laser beam that travels through the second optical path and enters the front-side optical system,
the fourth high reflective mirror reflects, toward the output coupling mirror, the laser beam incoming from the third high reflective mirror, and
the output coupling mirror transmits a part of the laser beam incoming from the fourth high reflective mirror to be output from the front-side optical system, and reflects a part of the laser beam to make a reflected part of the laser beam travel along the first optical path.

15. The laser apparatus according to claim 14, wherein
the front-side optical system includes a second actuator configured to change a posture of the third high reflective mirror, and a third actuator configured to change a posture of the fourth high reflective mirror.

16. The laser apparatus according to claim 1, wherein
a slit member having a slit through which the first optical path and the second optical path pass is provided between the front-side optical system and the chamber and between the rear-side optical system and the chamber, respectively.

17. The laser apparatus according to claim 1, wherein
the oscillator is a solid-state laser device.

18. An optical path adjusting method of a laser apparatus, the laser apparatus including
an oscillator configured to output a laser beam,
an amplifier configured to amplify the laser beam in a chamber including a pair of discharge electrodes,
a front-side optical system and a rear-side optical system disposed at positions facing each other across the chamber and constituting a ring resonator including a first optical path and a second optical path intersecting between the pair of discharge electrodes,
a front-side observation device that allows for observation of the first optical path and the second optical path between the front-side optical system and the chamber, and
a rear-side observation device that allows for observation of the first optical path and the second optical path between the rear-side optical system and the chamber,
the first optical path being an optical path through which the front-side optical system outputs, toward the rear-side optical system, the laser beam incoming from the oscillator,
the second optical path being an optical path through which the rear-side optical system outputs, toward the front-side optical system, the laser beam incoming through the first optical path,
the optical path adjusting method comprising:
adjusting the rear-side optical system through observation of the first optical path and the second optical path using the rear-side observation device;
adjusting the rear-side optical system through observation of the first optical path and the second optical path using the front-side observation device; and
adjusting the front-side optical system through observation of an optical path of the laser beam output from the amplifier.

19. The optical path adjusting method according to claim 18, further comprising
adjusting a beam steering device disposed on an optical path of the laser beam between the oscillator and the amplifier through observation of the first optical path and the second optical path using the front-side observation device and the rear-side observation device.

20. An electronic device manufacturing method comprising:
generating a laser beam with a laser apparatus, the laser apparatus including
an oscillator configured to output a laser beam,
an amplifier configured to amplify the laser beam in a chamber including a pair of discharge electrodes,
a front-side optical system and a rear-side optical system disposed at positions facing each other across the chamber and constituting a ring resonator including a first optical path and a second optical path intersecting between the pair of discharge electrodes,
a front-side observation device that allows for observation of the first optical path and the second optical path between the front-side optical system and the chamber, and
a rear-side observation device that allows for observation of the first optical path and the second optical path between the rear-side optical system and the chamber,
the first optical path being an optical path through which the front-side optical system outputs, toward the rear-side optical system, the laser beam incoming from the oscillator,
the second optical path being an optical path through which the rear-side optical system outputs, toward the front-side optical system, the laser beam incoming through the first optical path;
outputting the laser beam to an exposure apparatus; and
exposing a photosensitive substrate to the laser beam within the exposure apparatus in order to manufacture an electronic device.
